(19) United States
(12) Patent Application Publication
(10) Pub. No.: US 2013/0193777 A1
(43) Pub. Date: Aug. 1, 2013

(54) LINEAR MOTOR SYSTEM

(71) Applicant: Fred Sommerhalter, JR., Oyster Bay, NY (US)

(72) Inventor: Fred Sommerhalter, JR., Oyster Bay, NY (US)

(73) Assignee: Rockwell Automation Technologies, Inc., Mayfield Heights, OH (US)

(21) Appl. No.: 13/364,184

(22) Filed: Feb. 1, 2012

(51) Int. Cl. H02K 41/02; B23P 17/04; H02K 15/03

(52) U.S. Cl. 310/12.02; 310/12.31; 310/12.24; 29/428

(57) ABSTRACT

An automation system is provided. The automation system includes a rail assembly comprising a first stop block at a first end and a second stop block at a second end. The automation system further includes a magnet assembly mounted on the rail assembly between the first and second stop blocks and a slide assembly configured to move back and forth over the rail assembly between the first block and the second block. The automation system further includes a linear motor coupled to the slide assembly and magnetically coupled to the rail assembly, the linear motor configured to generate a magnetic field that interacts with the magnetic assembly to provide a linear force that moves the slide assembly on the rail assembly.

### BACKGROUND

The invention relates generally to automation systems, and particularly to automation systems using linear motors.

In a variety of applications such as machining, robotic positioning, food processing and packaging applications, automation systems are employed. These automation systems typically include components such as actuators that move from one point of the system to another. Examples of actuators include ball-screw driven, linear motor driven, belt drives, linear actuators, etc.

These actuators are usually attached to an automation framework that provides a path for moving the components to different points in a system. The framework includes rail assemblies on which the actuators are mounted. The rail assemblies are often formed using T-slot extrusions.

In most cases, the actuators provide single axis motion and are built on a large stationary base. The base is also an extrusion typically made of aluminum or steel. These extrusions are highly machined and incorporate high accuracy bearing systems. The stationary base (along with the actuator) is then attached to the rail assembly to form the automation system.

However, in most applications high accuracy is not required for moving the actuator from one point to another. In addition, since the actuator is built on an extrusion an overall cost of the system is substantially increased. Accordingly, it would be desirable to develop an automation system that can enable movement of components from one point to another while minimizing the overall cost of the system.

### BRIEF DESCRIPTION

Briefly, according to one embodiment of the present invention, an automation system is provided. The automation system comprises a rail assembly comprising a first stop block at a first end and a second stop block at a second end. The automation system further includes a magnet assembly mounted on the rail assembly between the first and second stop blocks and a slide assembly configured to move back and forth over the rail assembly between the first block and the second block. The automation system further includes a linear motor coupled to the slide assembly and magnetically coupled to the rail assembly, the linear motor configured to generate a magnetic field that interacts with the magnetic assembly to provide a linear force that moves the slide assembly on the rail assembly.

In another embodiment, a linear motor kit attachable to a rail assembly of a desired length is provided. The kit comprises a magnet assembly adapted for mounting on the rail assembly, a slide assembly configured to move on the rail assembly and a linear motor coupled to the slide assembly and magnetically coupled to the rail assembly. The linear motor is configured to generate a magnetic field that interacts with the magnetic assembly to provide a linear force to move the slide assembly on the rail assembly.

In another embodiment, a method of making a linear motor assembly is provided. The method comprises cutting a standard rail assembly to a desired length, coupling a plurality of magnetic plates on the steel plate, securing a steel plate to the rail assembly attaching a slide assembly over the rail assembly using a plurality of rollers and coupling a linear motor to the slide assembly, wherein the linear motor is magnetically coupled to the rail assembly.

### DRAWINGS

These and other features, aspects, and advantages of the present invention will become better understood when the following detailed description is read with reference to the accompanying drawings in which like characters represent like parts throughout the drawings, wherein:

FIG. 1 illustrates one embodiment of an automation system implemented according to aspects of the present technique;

FIG. 2 is an exploded view of a slide assembly of FIG. 1 implemented according to aspects of the present technique;

FIG. 3 is an exploded view of a magnet assembly of FIG. 1 implemented according to aspects of the present technique; and

FIG. 4 is a flow chart illustrating a method for manufacturing a linear motor assembly according to aspects of the present technique.

### DETAILED DESCRIPTION

As discussed in detail below, embodiments of the present technique function provide an automation system for use in applications such as food processing applications, wet installations and chemical laden environments. References in the specification to “one embodiment”, “an embodiment”, “an exemplary embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

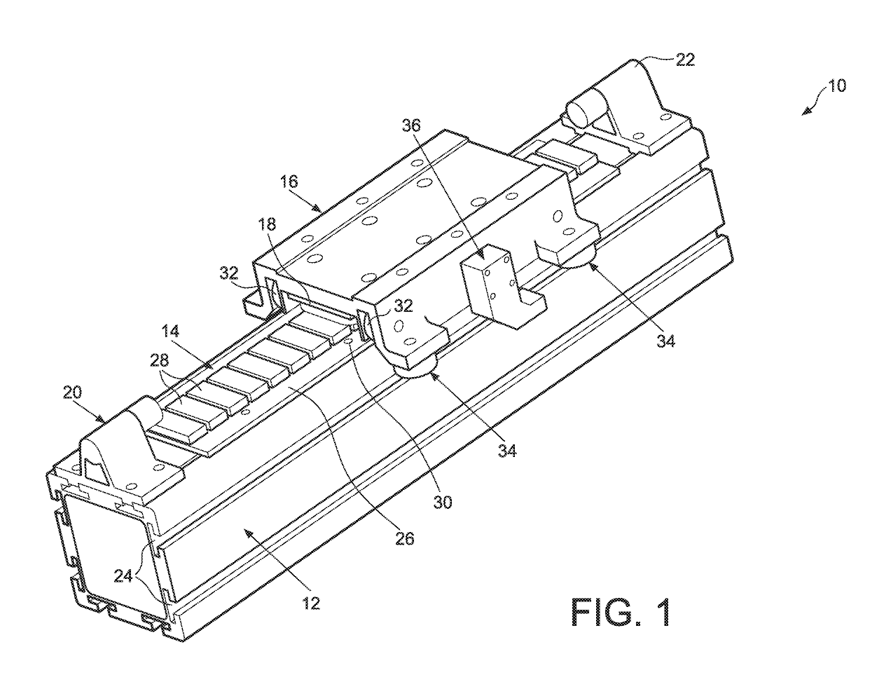

Turning now to drawings and referring first to FIG. 1, an automation system 10 is illustrated. The automation system 10 includes a rail assembly 12, a magnet assembly 14, a slide assembly 16 and a linear motor 18. Each component is described in further detail below.

The rail assembly 12 includes a first stop block 20 at a first end and a second stop block 22 at a second end. In one embodiment, the rail assembly is formed using a T-slot extrusion. In one embodiment, the T-slot extrusion includes two T-slots 24 on each side of the extrusion.

Magnet assembly 14 is mounted on the rail assembly 12 between the first and second stop blocks 20 and 22 respectively. The magnet assembly 14 includes a plate 26 and magnets 28. In one embodiment, the plate 26 is attached to the rail assembly 12 using bolts 30. Alternatively, the plate can be adhesively bonded to the rail assembly 12.

Slide assembly 16 is configured to move back and forth over the rail assembly between the first and second stop blocks 20 and 22. The slide assembly 16 includes multiple rollers that are in contact with the rail assembly 12. In one embodiment, the slide assembly 16 includes 4 vertical rollers 32 and 3 horizontal rollers 34 and 34A.

The linear motor 18 is coupled to the slide assembly 16 and magnetically coupled to the rail assembly 12. In operation, the linear motor 18 is configured to receive power from a power source (not shown in FIG. 1) such as a three-phase power supply. The three phase power supply is provided to the linear motor 18 through cable bracket 36. The rollers facilitate movement of the slide assembly 16 along the rail assembly 12.

A controlled magnetic field generated by the linear motor 18 on the magnet assembly 14 that produces a linear force for driving the slide assembly 14. It may be noted the linear motor 18 and the magnet assembly 14 have an environmentally protected design. Moreover, the materials for each of these components are selected for use in environments such as wet installations, chemical laden environments, among others. In a presently contemplated embodiment, the external shells of the assemblies are made of stainless steel.

In certain exemplary embodiments, the automation system 10 may include position sensors, such as Hall-effect sensors coupled to the linear motor 18 for sensing position information. In certain other embodiments, the automation system 10 may include such sensors in an encapsulated assembly external to the coil assembly 12.

As described above, the slide assembly 16 and the linear motor 18 are configured to move on the rail assembly 12. The components of the slide assembly are described in further detail below.

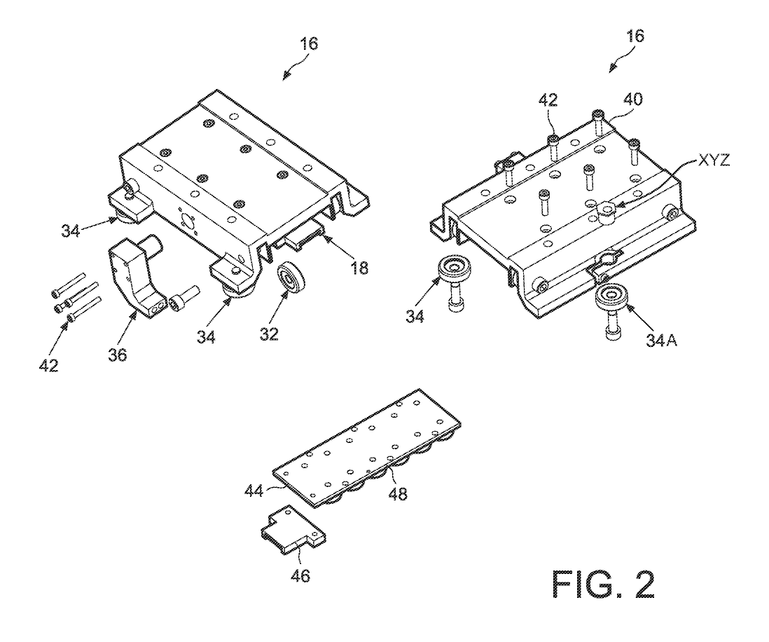

FIG. 2 is an exploded view of a slide assembly of FIG. 1 implemented in accordance with aspects of the present technique. The slide assembly 16 is formed using extrusion 40. The slide assembly 16 includes 4 vertical rollers 32 and 3 horizontal rollers 34 as shown.

The vertical rollers 32 and the horizontal rollers 34 facilitate movement of the slide assembly 16 over the rail assembly 12. In particular, the vertical rollers 32 are configured to control a height between the rail assembly 12 and the slide assembly 16. Similarly, the horizontal rollers 34 are configured to provide stability to the slide assembly 16. Horizontal roller 34A is mounted to an eccentric shaft XYX which can be rotated to provide required preload against rollers 34. The preload can also be created with a spring or a flexure.

The slide assembly 16 further includes the linear motor 18 that is coupled to the slide assembly 16 using bolts 42. As can be seen in FIG. 2, the linear motor 18 is designed to move over the magnet assembly 14. The linear motor 18 includes coil assembly 44 which has a plurality of coil windings with a laminated iron core. The slide assembly 16 may further include a feedback module 46 coupled to the coil assembly 44.

The feedback module 46 may comprise a sensor for sensing position and/or motion information of the slide assembly 16. As will be appreciated by those skilled in the art, the sensed signals may be processed (at least partially) within the slide assembly 16, or fully by external circuitry. In either case, position signals may be used to derive velocity signals and acceleration signals, where desired, and any such signals may be used as feedback to accurately position and move the slide assembly 16 as needed in the particular application.

The linear motor 18 is coupled to a three phase power source (not shown) through cables that are routed through cable bracket 36. The cable bracket 36 is secured to the slide extrusion 40 using screws 49 as shown. The cable bracket 36 may also be used to route feedback cables from the feedback module 46. As will be appreciated by those skilled in the art, the linear motor may 18 include other suitable components such as sealed cable connectors for facilitating connection with a power supply and a controller respectively. The linear motor 18 is designed to move over the magnet assembly 14. The components of the magnet assembly 14 are described in further detail below.

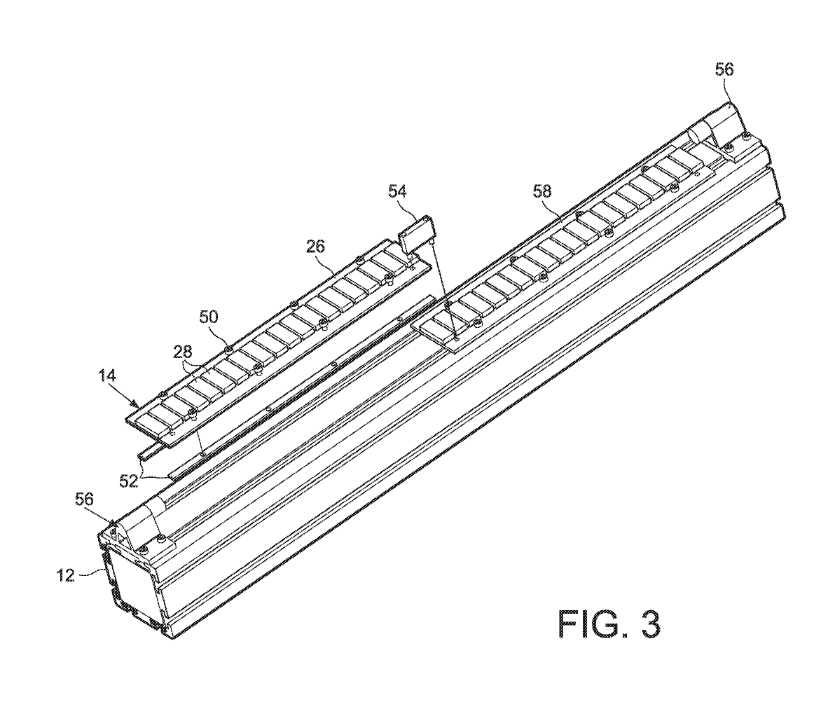

FIG. 3 is an exploded view of the magnet assembly 14 of FIG. 1 in accordance with aspects of the present technique. As illustrated, the magnet assembly 14 includes a plurality of magnets such as represented generally by reference numeral 28, mounted on a magnet mounting plate 26. The magnets 28 may be mounted on the magnet mounting plate 18 using a suitable adhesive. In this exemplary embodiment, the magnet mounting plate is made of carbon steel or magnetic stainless steel.

In certain embodiments, the magnet plate 26 may be mounted on the rail assembly 12 via fasteners such as represented by reference numeral 50. The fasteners may be clamped to a magnet clamp strip 52 which are then installed in the T-slots to the rail assembly 12.

In this exemplary embodiment, a second magnet assembly 58 is also mounted on rail assembly 12. Magnet assemblies 14 and 58 are clamped together using a magnet spacing tool 54. In the illustrated embodiment, the magnet assembly 14 includes other suitable components such as stop blocks 56.

As can be appreciated by those skilled in the art, the magnet assembly 14 along with the slide assembly 16 and the linear motor 18 may form a linear motor kit that can be attached to a rail assembly. The rail assembly 12 may be a part of an automation framework. The rail assembly 12 may include a standard T-slot extrusion. Thus, the magnetic assembly 14 and the slide assembly 16 are directly attached to the rail assembly 12. The manner in which the linear motor kit can be assembled is described in further detail below.

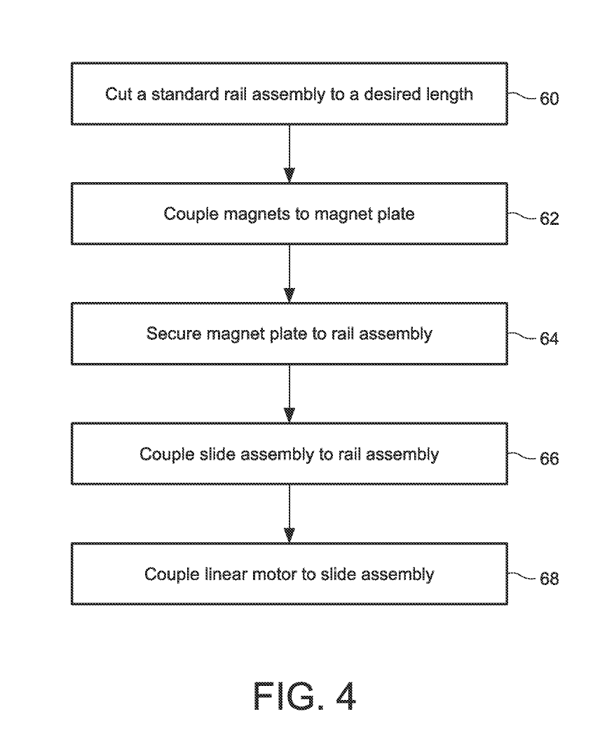

FIG. 4 is a flow chart illustrating a method for manufacturing a linear motor assembly according to aspects of the present technique. The method begins at step 60, where a standard rail assembly is cut to a desired length. In one embodiment, the rail assembly is a T-slot extrusion. Further, the T-slot extrusion includes at least two T-slots on each side. The T-slot extrusion may be formed using aluminum or stainless steel.

At step 62, a plurality of magnets is coupled to the magnet plate. In one embodiment, the magnets are coupled to the magnet plate using an adhesive. It may be noted that the plurality of magnets along with the magnet plate forms the magnet assembly as described in FIG. 1.

At step 64, a magnet plate is secured to the rail assembly. In one embodiment, the magnet plate is secured to the rail assembly using bolts. In another embodiment, the magnet plate is secured to the rail assembly using an adhesive. It may be noted that, several magnet plates may be secured to a single rail assembly.

At step 66, a slide assembly is coupled to the rail assembly using a plurality of rollers. In one embodiment, the plurality of rollers includes vertical rollers and horizontal rollers. The vertical rollers are configured to control a height between the rail assembly and the slide assembly. Similarly, the horizontal rollers are configured to provide stability to the slide assembly.

At step 68, a linear motor is coupled to the slide assembly. The linear motor is magnetically coupled to the rail assembly. In one embodiment, the linear motor includes coil assembly which may include a plurality of coil windings and a laminated iron core. The slide assembly may further include a feedback module that comprise a sensor configured to sense a position and/or motion information of the slide assembly. As will be appreciated by those skilled in the art, the sensed signals from the feedback module may be processed (at least partially) via a processing circuitry within the slide assembly, or fully by external circuitry.

The various aspects of the structures described hereinabove may be used for automotive systems for use in machining, robotic positioning and food processing and packaging applications. As described above, the technique mounts a linear motor on a slide assembly on to a rail assembly such as a T-slot extrusion which is already a part of the automation framework. As will be appreciated by those skilled in the art, the use of such a technique eliminates the need for a separate extrusion for the linear motor system thereby reducing an overall cost of the system.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An automation system comprising:
a rail assembly comprising a first stop block at a first end and a second stop block at a second end;
a magnet assembly mounted on the rail assembly between the first and second stop blocks;
a slide assembly configured to roll back and forth over the rail assembly from the first end to the second end;
a linear motor coupled to the slide assembly and magnetically coupled to the rail assembly, the linear motor configured to generate a magnetic field that interacts with the magnetic assembly to generate a linear force that moves the slide assembly.

2. The automation system of claim 1, wherein the rail assembly comprises a T-slot extrusion.

3. The automation system of claim 2, wherein the T-slot extrusion includes at least two T-slots on each side.

4. The automation system of claim 1, wherein the magnetic assembly comprises a magnet plate coupled to the rail assembly and a plurality of magnets mounted on the magnet plate.

5. The automation system of claim 4, wherein the magnet plate is adhesively bonded to the rail assembly.

6. The automation system of claim 4, wherein the magnet plate is bolted to the rail assembly.

7. The automation system of claim 1, wherein the slide assembly comprises vertical rollers and horizontal rollers.

8. The automation system of claim 7, wherein the vertical rollers are configured to control a height of the slide assembly.

9. The automation system of claim 7, wherein the horizontal rollers are configured to provide stability to the slide assembly.

10. A linear motor kit attachable to a rail assembly of a desired length, the kit comprising:
a magnet assembly adapted for mounting on the rail assembly,
a slide assembly configured to roll over the rail assembly; and
a linear motor coupled to the slide assembly and configured to magnetically couple to the rail assembly, the linear motor configured to generate a magnetic field that interacts with the magnetic assembly to generate a linear force that moves the slide assembly.

11. The linear motor kit of claim 10, wherein the rail assembly comprises a first stop block at a first end and a second stop block at a second end.

12. The linear motor kit of claim 10, wherein the rail assembly comprises a T-slot extrusion.

13. The linear motor kit of claim 10, wherein the T-slot extrusion includes at least two T-slots on each side.

14. The linear motor kit of claim 10, wherein the T-slot extrusion is formed using aluminum or stainless steel.

15. The linear motor kit of claim 10, wherein the magnetic assembly comprises a magnet plate coupled to the rail assembly and a plurality of magnets mounted on the magnet plate.

16. The linear motor kit of claim 10, wherein the slide assembly comprises vertical rollers and horizontal rollers.

17. A method of making a linear motor assembly, the method comprising:
cutting a standard rail assembly to a desired length,
coupling a plurality of magnets on the magnet plate;
securing a magnet plate to the rail assembly;
attaching a slide assembly over the rail assembly using a plurality of rollers; and
coupling a linear motor to the slide assembly, wherein the linear motor is magnetically coupled to the rail assembly.

18. The method of claim 17, further comprising securing a first stop block at a first end of the rail assembly and a second stop block at a second end of the rail assembly, wherein the magnet plate is secured between the first block and the second block.

19. The method of claim 17, wherein the rail assembly is a T-slot extrusion.

20. The method of claim 17, wherein the plurality of rollers include vertical rollers and horizontal rollers.
